(19) United States
(12) Patent Application Publication
(10) Pub. No.: US 2010/0143873 A1
(43) Pub. Date: Jun. 10, 2010

(54) APPARATUS AND METHOD FOR TASK BASED LANGUAGE INSTRUCTION

(76) Inventors: Gregory Keim, Broadway, VA (US); Jack August Marmorstein, Harrisonburg, VA (US); Ronald Bryce Inouye, Harrisonburg, VA (US); Anthony Lopez, Harrisonburg, VA (US); Michael Scott Fulkerson, Harrisonburg, VA (US)

Correspondence Address: Kaplan Gilman & Pergament LLP, 1480 Route 9 North, Woodbridge, NJ, 07095, US

(21) Appl. No.: 12/329,216

(22) Filed: Dec. 5, 2008

(51) Int. Cl. G09B 19/00

(52) U.S. Cl. 434/156

(57) ABSTRACT

A computer-implemented system and method for teaching a target language are disclosed that may include providing a pool of tasks associated with instruction of the target language by a computing system; receiving a query from a user requesting instruction of a target task from among the pool of tasks; identifying a sequence of tasks beneficial for teaching the target task; and presenting a lesson plan, including the beneficial sequence of language tasks, to the user in response to the user query, wherein the lesson plan includes the target task and at least one supporting task.

### BACKGROUND OF THE INVENTION

The present invention relates generally to teaching machines and, more particularly concerns a system and method for teaching a language.

Traditional methods for teaching a language, in particular a foreign language, are far from enjoyable for students. Students spend a great deal of time learning rules of grammar and syntax and generally learn by memorizing words in the target language (the language being learned) that are translations of corresponding words in a source language. The only exposure to correct pronunciation might be on a recording or during discussions in a classroom. On such occasions, the student finds himself mentally composing his recitation in his native language and then translating it. The usual result is a halting, stilted recital, replete with grammatical and syntactic errors introduced by the translation process. The foregoing approach generally does not enable the language learner to converse fluently in the target language.

In contrast, upon first learning a language, young children are fully immersed in a natural learning process in which they learn words, grammar and syntax interactively through deductive reasoning, in context, and by emulating others. In time, children develop a flowing communication style, without the need to translate or to be concerned about rules. It would be desirable to be able to emulate this kind of learning process in learning a second language.

Systems of teaching a user language using immersion are known to some extent in the prior art. However, to best measure the user's progress, the language student should be prompted to speak naturally. Simply showing the user target language text to be read aloud is less than optimum, because read speech is not spoken the same way as natural speech not being read. Thus, attempting to gauge student progress by measuring an ability to read prepared text is generally not effective.

Accordingly, there exists a need in the art for a language teaching system that can be used to cause natural speech to occur in a target language to assist the user to practice the target language and to speak naturally and to assist a teaching machine to effectively measure the progress of the student.

Moreover, existing language teaching systems provide a single, inseparable learning curriculum that generally requires considerable expenditure of time and effort to master. This arrangement makes it impractical to learn only a selected portion of a language within a reasonable period of time. Accordingly, there is a need in the art for a language teaching system that will enable a language student to effectively and quickly learn a selected portion of a target language.

### SUMMARY OF THE INVENTION

According to one aspect, the invention is directed to a computer-implemented method for teaching a target language, that may include providing a pool of tasks associated with instruction of the target language by a computing system; receiving a query from a user requesting instruction of a target task from among the pool of tasks; identifying a sequence of tasks beneficial for teaching the target task; and presenting a lesson plan, including the beneficial sequence of language tasks, to the user in response to the user query, wherein the lesson plan includes the target task and at least one supporting task.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a schematic block diagram of a learning environment including a computer system and audio equipment suitable for practicing an embodiment of the present invention;

FIG. 2 is a flow diagram showing a sequence of steps that may be practiced in accordance with an embodiment of the present invention;

FIG. 3 is a block diagram showing a list of exemplary target-language teaching tasks in accordance with an embodiment of the present invention;

FIG. 4 is a block diagram showing a preferred sequence of teaching tasks in accordance with an embodiment of the invention;

FIG. 5 is a block diagram showing a preferred sequence of teaching tasks in accordance with an embodiment of the invention; and

FIG. 6 is a block diagram providing a detailed view of a computer system usable in conjunction with an embodiment of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

Herein, the target language is the language being taught. The term “source language” generally refers to the language the student is starting from. In some cases, learning materials may use the source language for presentation purposes. The source language may be, but need not be, the native language of one or more students in a learning environment. For example, a student's native language may be Russian and may learn Spanish using learning materials in which one or more instructions are provided in English, on the assumption that most language learners are native English speakers. In this case, the source language is English, even though the student's native language is Russian.

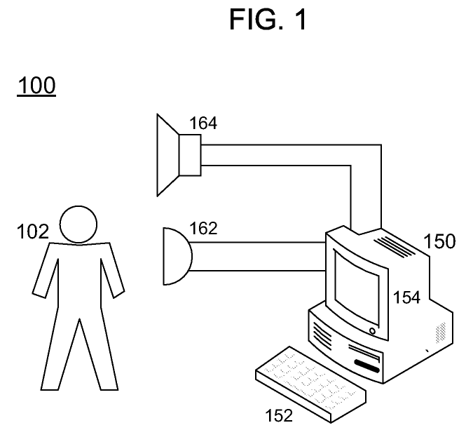

FIG. 1 is a schematic block diagram of a learning environment 100 including a computer system 150 and audio equipment suitable for teaching a target language to student 102 in accordance with an embodiment of the present invention. Learning environment 100 may include student 102, computer system 150, which may include keyboard 152 (which may have a mouse or other graphical user-input mechanism embedded therein) and/or display 154, microphone 162 and/or speaker 164. The computer 150 and audio equipment shown in FIG. 1 are intended to illustrate one way of implementing an embodiment of the present invention. Specifically, computer 150 (which may also referred to as “computer system 150”) and audio devices 162, 164 preferably enable two-way audio-visual communication between the student 102 (which may be a single person) and the computer system 150.

In one embodiment, software for enabling computer system 150 to interact with student 102 may be stored on volatile or non-volatile memory within computer 150. However, in other embodiments, software and/or data for enabling computer 150 may be accessed over a local area network (LAN) and/or a wide area network (WAN), such as the Internet. In some embodiments, a combination of the foregoing approaches may be employed. Moreover, embodiments of the present invention may be implemented using equipment other than that shown in FIG. 1. Computers embodied in various modern devices, both portable and fixed, may be employed including but not limited to Personal Digital Assistants (PDAs), cell phones, among other devices.

Embodiments of the invention disclosed herein may be directed to identifying an optimal sequence of tasks suitable for teaching a student a target task. The resulting sequence of tasks may also be referred to herein as a lesson plan. Each lesson plan may include one target task, and one or more supporting task. A supporting task is a language task that accumulated data indicates is helpful to the teaching of the target task, and may be taught to the student before or after the target task.

Preferably, data indicative of learning effectiveness (pedagogical effectiveness data) of various tasks may be gathered in the course of teaching tasks using a variety of task sequences. Preferably, information may be gleaned from such gathered data to determine a preferred, or optimal, sequence of tasks to be taught to a student, in order to optimize the success in teaching a target task, without having to teach an entire language curriculum. Supporting tasks may be located prior to, or after, a target task, in an ultimate sequence of tasks. Thus, in some embodiments, it is possible that one or more supporting tasks may be taught after the target task is taught, if accumulated task teaching success data indicates that such an order of task instruction produces desirable results.

An embodiment of the present invention preferably enables a teaching system and/or method to teach a desired target task more effectively and/or more completely than when teaching the target task alone. Moreover, an embodiment of the present invention preferably enables a teaching system and/or method to learn a target task more quickly, by teaching a selection of one or more preliminary language tasks, than teaching an entire curriculum. In some cases, repetition of related instruction steps occurring within different teaching tasks within a sequence of tasks may also lead to longer retention (i.e. a longer period of successful memorization) of material in the target task.

Various criteria may be employed to identify an optimal task sequence, such as, but not limited to, the total number of tasks in the sequence, the time needed for the supporting tasks, the utility of the preliminary tasks to the student, the amount of time available to the student for studying the task sequence, and/or where applicable, the cost variation among different available task sequences.

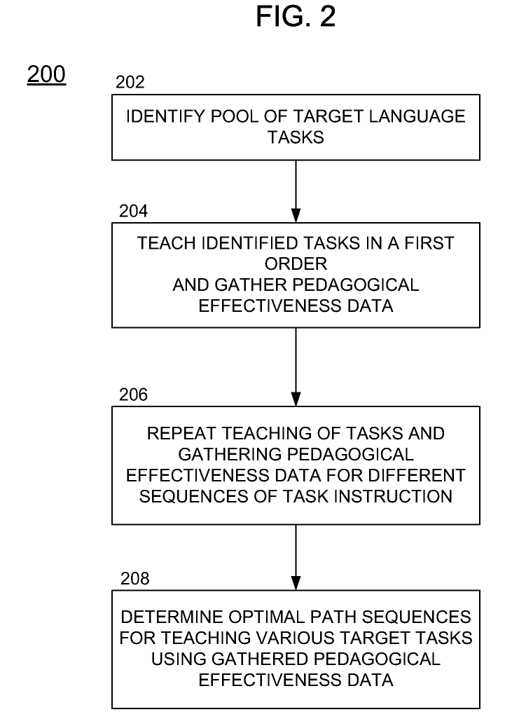

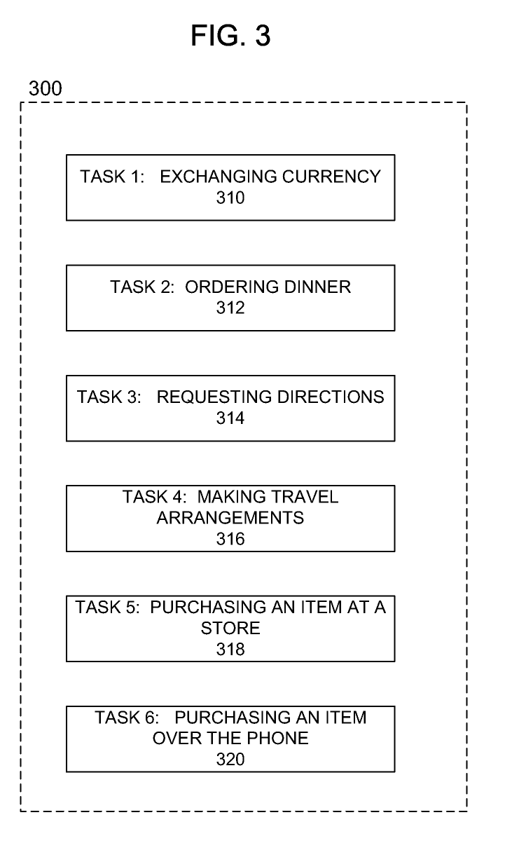

FIG. 2 is a flow diagram showing a sequence 200 of steps that may be practiced in accordance with an embodiment of the present invention. At step 202, a pool of target language tasks may be identified. An exemplary pool of available of language tasks is shown in FIGS. 3-5. The pool of language tasks from which learning effectiveness data may be gathered may be linked by some common theme such as travel, commerce, a particular hobby etc. However, tasks related to any topic may be included in the pool of tasks for which learning effectiveness data is gathered.

At step 204, tasks in the pool of tasks may be taught to one or more students in a first order while data is gathered that is indicative of the effectiveness with which each task was learned by the student. Herein, the effectiveness with which a task is learned by a student is considered substantially equivalent to the effectiveness with which the task was taught by a system or method in accordance with an embodiment of the present invention. In the event that tasks taught to a student after a target task influence the effectiveness of retention of material learned by the student during teaching of the target task, pedagogical effectiveness data related to the teaching of a target task may be gathered after teaching one or more supporting tasks after teaching the target task.

At step 206, the tasks within a pool of tasks may be taught to a student 102 using a variety of task sequences, while pedagogical effectiveness data is gathered for each instance of teaching a task. In one embodiment, for the sake of thoroughness, all possible permutations of task teaching sequences may be practiced, and effectiveness data gathered, to determine optimal task teaching sequences. However, in other embodiments, for the sake of expediency, a more limited number of task teaching sequences may be conducted that are believed most likely to yield desired results. At step 208, the gathered data may be analyzed to determine optimal path sequences for one or more target tasks within the pool of tasks.

In FIGS. 3-5, an exemplary pool 300 of tasks is presented along with various exemplary task sequences. FIG. 3 is a block diagram showing an exemplary pool 300 of target tasks in accordance with an embodiment of the present invention. Task pool 300 may include task 1 310, task 2 312, task 3 314, task 4 316, task 5 318 and/or task 6 320. The pool 300 of tasks shown in FIG. 3 is exemplary. It will be appreciated by those having skill in the art that many other learning tasks could be employed in addition to, or in place of, the tasks shown in FIG. 3.

Once optimal path sequences have been determined for various target tasks, a user 102 may enter a query to a teaching machine, such as computer system 150 (other machine 150), identifying a target task to be learned by the user and taught by the machine 150. Machine 150 may respond to the query from user 102 by presenting a recommended sequence of tasks for teaching the target task identified in the user 102 query. The sequence of tasks (also referred to herein as a “lesson plan”) recommended by machine 150 preferably includes the requested target task and one or more supporting tasks. As stated elsewhere herein, a supporting task is a language task included in the lesson plan which enhances the pedagogical effectiveness of the instruction of the target task. Supporting tasks may be located before and/or after the target task in the lesson plan.

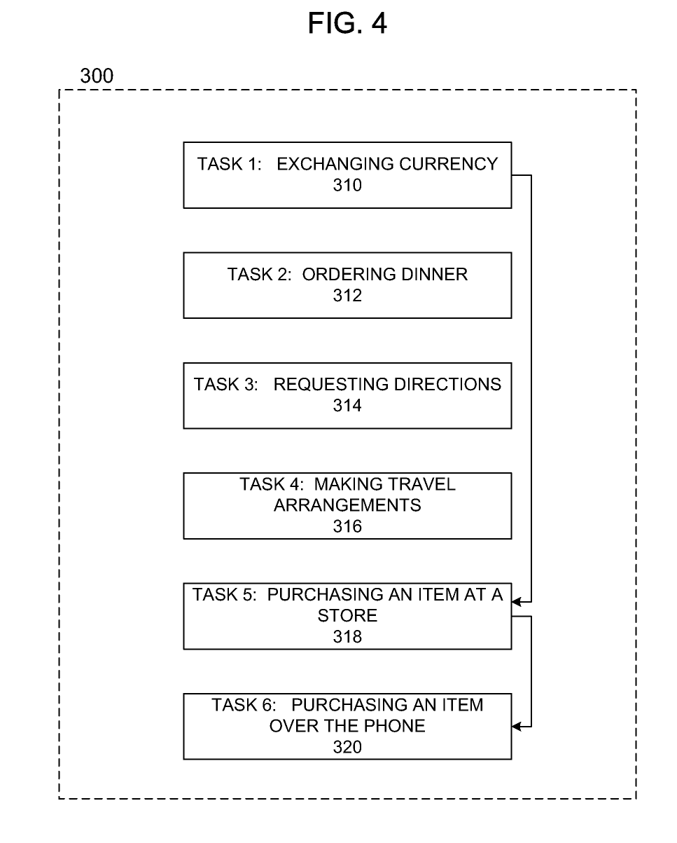

FIG. 4 is a block diagram showing a pool 300 of tasks. Two task sequences are shown in FIG. 4, associated with two respective target tasks, which are discussed in turn below. In the following example, it is presumed that accurate pedagogical effectiveness data has been gathered for the respective target tasks. However, the details of such data acquisition are not discussed in this section.

Continuing with the example, the arrowed lines in FIG. 4 show pedagogically successful task sequences. Thus, in this example, Task 5 318 is learned most effectively if preceded by task 1 310. Thus, a link may be established such that upon a student 102 entering a query, or request, to learn Task 5 318, a method according to one embodiment preferably suggests learning task 1 310 first. Thus, in this case, a user query requesting task 5 318 preferably yields a lesson plan including the task sequence: 1) Task 1 310; and 2) Task 5 318. In this situation, task 1 310 is the sole supporting task and is preferably taught to user 102 prior to teaching target task 5 318.

Similarly, consistent with the lower arrowed line, when a student 102 enters a query indicating a request to learn Task 6 320, a method according to one embodiment of the invention preferably identifies a lesson plan including the following sequence of tasks: 1) Task 1 310; 2) Task 5 318, and then 3) Task 6 320. Thus, in this case, Task 6 320 is the target task, and task 1 310 and task 5 318 are supporting tasks and are preferably taught to user 102 prior to teaching target task 6 320.

In this manner, the student 102 preferably learns Task 6 320 using the above-stated sequence of tasks than when learning Task 6 320 by itself (according to the hypothetical pedagogical effectiveness data of this example). Moreover, using the described approach, student 102 learns the content of Task 1 310 and Task 5 318, the knowledge of which tasks may also beneficial to student 102 in addition to the contribution of these tasks to the effectiveness of learning of task 6 320 by the student 102.

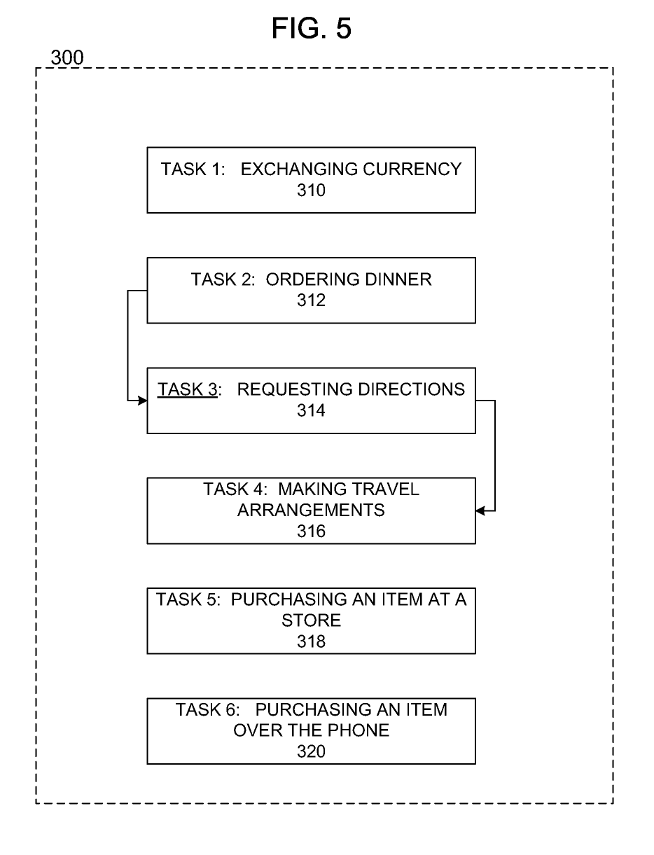

FIG. 5 shows an additional exemplary pedagogically successful task sequence. In the example of FIG. 5, Task 3 314 (“requesting directions”) is the target task, as indicated by the underlining of the text “Task 3”. In this example, consistent with the arrowed lines, the pedagogical effectiveness data indicates that the optimal sequence of task teaching (which may also be referred to as “task instruction”) is Task 2 312, Task 3 314, and Task 4 316. Thus, upon a user 102 entering a request to learn task 3 314, machine 150 preferably presents a lesson plan including the following sequence of tasks: (1) task 2 312; (2) task 3 314; and (3) Task 4 316. In this case, Task 3 314 is the target task, and Task 2 312 and Task 4 316 are supporting tasks, with task 2 312 preceding the target task, and task 4 316 succeeding the target task in the preferred sequence of tasks in the machine-recommended lesson plan.

The discussion of FIGS. 3-5 is directed to an exemplary set of language instruction tasks. It will be appreciated that the present invention is not limited to the particular language tasks illustrated in FIGS. 3-5. Instead the principles of the present invention may be applied to language tasks covering any desired topic in the field of language instruction. Moreover, the concepts disclosed herein are not limited to teaching languages, but may be extended to instruction of other subjects as well.

The instruction of individual language tasks discussed herein may be conducted in accordance with the disclosure of U.S. patent application Ser. Nos. 11/846,188, filed Aug. 28, 2007, entitled “Language Teaching Method and Apparatus,” the disclosure of which is hereby incorporated herein by reference in its entirety.

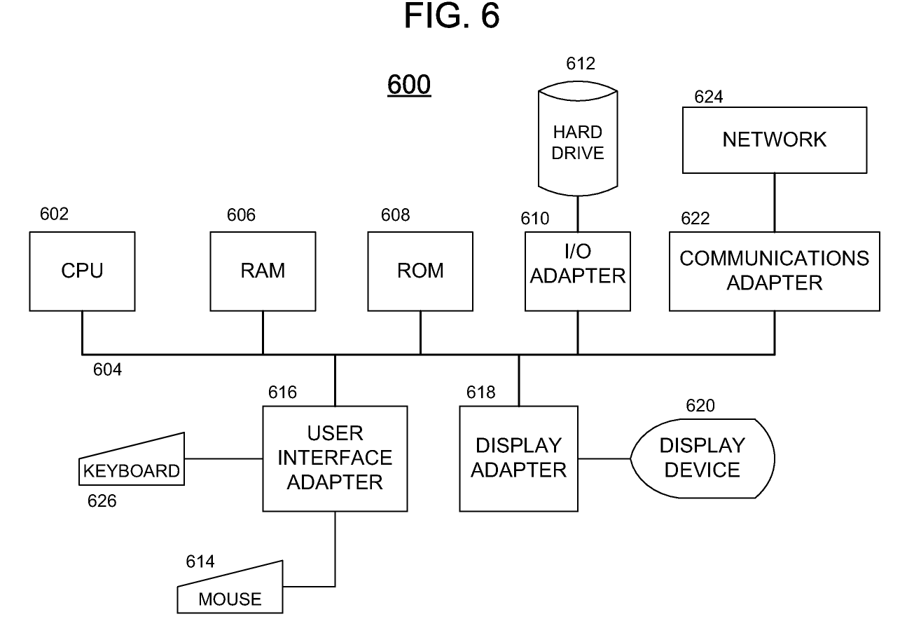

FIG. 6 is a block diagram of a computer system 600 usable in conjunction with an embodiment of the present invention. Computer system 600 of FIG. 6 may generally correspond to computer system 150 of FIG. 1. Suitable audio interface equipment may be provided in computer system 600 of FIG. 6 to enable CPU 602 interact with microphone 162 and/or speaker 164 of FIG. 1.

In an embodiment, central processing unit (CPU) 602 may be coupled to bus 604. In addition, bus 604 may be coupled to random access memory (RAM) 606, read only memory (ROM) 608, input/output (I/O) adapter 610, communications adapter 622, user interface adapter 606, and display adapter 618.

In an embodiment, RAM 606 and/or ROM 608 may hold user data, system data, and/or programs. I/O adapter 610 may connect storage devices, such as hard drive 612, a CD-ROM (not shown), or other mass storage device to computing system 600. Communications adapter 622 may couple computing system 600 to a local, wide-area, or global network 624. User interface adapter 616 may couple user input devices, such as keyboard 626 and/or pointing device 614, to computing system 600. Moreover, display adapter 618 may be driven by CPU 602 to control the display on display device 620. CPU 602 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Notably, with language learning now being available for use over the Internet, language teaching programs can easily compile vast amounts of statistical data from a large number of users seeking to learn a target language. Therefore, it is possible to conveniently compile data to ascertain whether, for example, most users that can perform a specified task in a particular target language can also perform a specified support task. By utilizing the order of tasks, rather than determining the order in which specific words in the foreign language are taught, a more natural learning experience is achieved.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A computer-implemented method for teaching a target language, comprising:
providing a pool of tasks associated with instruction of the target language by a computing system;
receiving a query from a user requesting instruction of a target task from among the pool of tasks;
identifying a sequence of tasks beneficial for teaching the target task; and
presenting a lesson plan, including the beneficial sequence of language tasks, to the user in response to the user query, wherein the lesson plan includes the target task and at least one supporting task.

2. The method of claim 1 further comprising:
teaching the tasks to the student in the identified sequence.

3. The method of claim 1 wherein the step of identifying comprises:
accumulating data including at least one indicium of success in teaching the target task to at least one student.

4. The method of claim 3 wherein the step of identifying further comprises:
analyzing the accumulated data to establish an optimal sequence of the tasks to be taught to the at least one student, based on the at least one indicium of success; and
establishing the lesson plan for the target language task in accordance with the optimal sequence of tasks.

5. The method of claim 1 wherein at least one said supporting task is located prior to the target task in the sequence of tasks in the lesson plan.

6. The method of claim 1 wherein at least one said supporting task is located after the target task in the sequence of tasks in the lesson plan.

7. The method of claim 3 wherein the at least one indicium of success is selected from the group consisting of: (a) the speed with which the target task is learned; (b) the completeness of learning of the target task by the student; and (c) the duration of retention of subject matter of the target task by the student.

8. The method of claim 1 wherein the pool of language tasks includes a plurality of tasks selected from the group consisting of: ordering dinner; booking airline travel; requesting directions to a travel destination.

9. A computer program product comprising a computer readable medium having computer program logic recorded thereon for teaching a target language to a student, the computer program product comprising:
data representing a pool of tasks associated with instruction of the target language by a computing system, stored on the computer readable medium;
code for receiving a query from a user requesting instruction of a target task from among the pool of tasks;
code for identifying a sequence of tasks beneficial for teaching the target task; and
code for presenting a lesson plan, including the beneficial sequence of language tasks, to the user in response to the user query, wherein the lesson plan includes the target task and at least one supporting task.

10. The computer program product of claim 9 further comprising:
code for teaching the tasks to the student in the identified sequence.

11. The computer program product of claim 9 wherein the code for identifying comprises:
code for accumulating data including at least one indicium of success in teaching the target task to at least one student.

12. The computer program product of claim 11 wherein the code for identifying further comprises:
code for analyzing the accumulated data to establish an optimal sequence of the tasks to be taught to the at least one student, based on the at least one indicium of success; and
code for establishing the lesson plan for the target language task in accordance with the optimal sequence of tasks.

13. The computer program product of claim 9 wherein at least one said supporting task is located prior to the target task in the sequence of tasks in the lesson plan.

14. The computer program product of claim 9 wherein at least one said supporting task is located after the target task in the sequence of tasks in the lesson plan.

15. The computer program product of claim 11 wherein the at least one indicium of success is selected from the group consisting of: (a) the speed with which the target task is learned; (b) the completeness of learning of the target task by the student; and (c) the duration of retention of subject matter of the target task by the student.

16. The computer program product of claim 12 wherein the pool of language tasks includes a plurality of tasks selected from the group consisting of: ordering dinner; booking airline travel; requesting directions to a travel destination.

17. A method comprising interacting over a data network with a plurality of learners of a target language, maintaining data indicative of the tasks and support tasks, and determining an order in which to learn tasks in said target language based upon said data.

18. The method of claim wherein said determining is also based upon an entered task that a user desires to learn.
